(19) United States
(12) Patent Application Publication
(10) Pub. No.: US 2025/0173489 A1
(43) Pub. Date: May 29, 2025

(54) VIRTUAL SENSING METHOD AND SYSTEM FOR VARIABLE INLET GUIDE VANE CONTROL FLUID DEVICE OPERATING FREQUENCY BASED ON METAMODEL

(71) Applicant: Korea Electronics Technology Institute, Seongnam-si (KR)

(72) Inventors: Yong Woo SHIN, lncheon (KR); Sung Jin YANG, Seoul (KR); Jong Rak CHOI, lncheon (KR); Rae Eun KIM, Seoul (KR); Hyun Woo HAN, Seoul (KR)

(73) Assignee: Korea Electronics Technology Institute, Seongnam-si (KR)

(21) Appl. No.: 18/928,891

(22) Filed: Oct. 28, 2024

(30) Foreign Application Priority Data
Nov. 23, 2023 (KR) 10-2023-0164043

(51) Int. Cl. G06F 30/28; G01L 27/02; G06F 111/10

(52) U.S. Cl. CPC G06F 30/28; G01L 27/02; G06F 2111/10

(57) ABSTRACT

There are a method and a system for virtual sensing, which predict a current operating frequency of a variable IGV control fluid device (for example, a pump, a blower) based on a metamodel. A virtual sensing method for sensing a variable IGV control fluid device operating frequency based on a metamodel according to an embodiment includes: collecting, by a communication unit, input characteristic data from a fluid device system; and predicting, by a processor, output characteristic data by applying the input characteristic data to a metamodel which is a machine learning model, and the input characteristic data is two or more of a fluid pressure (P), a fluid flow rate (Q), and an IGV angle (β), and the output characteristic data is an operating frequency (N) of the fluid device.

### CROSS-REFERENCE TO RELATED APPLICATION(S) AND CLAIM OF PRIORITY

This application is based on and claims priority under 35 U.S.C. § 119 to Korean Patent Application No. 10-2023-0164043, filed on Nov. 23, 2023, in the Korean Intellectual Property Office, the disclosure of which is herein incorporated by reference in its entirety.

### BACKGROUND

### Field

The disclosure relates to a method and a system for virtual sensing, and more particularly, to a method and a system for virtual sensing, which predict a current operating frequency of a variable inlet guide vane (IGV) control fluid device (for example, a pump, a blower) based on a metamodel.

### Description of Related Art

A fluid device (for example, a pump, a blower) may perform a channel opening control method or a fluid device operating frequency (the number of rotations) control method to operate at a specific operating time.

The channel opening control method or the fluid device operating frequency (the number of rotations) control method has the advantage of technically simple implementation, but has the disadvantage that the operation efficiency of the fluid device is degraded.

To solve this problem, a variable IGV control method has been developed, but due to mechanical characteristics of the variable IGV, there is a risk that the IGV oscillates when a load is applied to the system or that the fluid device operates in an uncontrolled state.

This problem may be typically inferred by monitoring a change in the operating frequency of the fluid device, but it may be difficult to measure the frequency depending on the operating environment of the fluid device, and it may be impossible to measure the operating frequency due to damage to a sensor.

### SUMMARY

The disclosure has been developed in order to solve the above-described problems, and an object of the disclosure is to provide a method and a system for virtual sensing, which predict a current operating frequency of a fluid device by using a metamodel, which is a machine learning model, in order to evaluate stability in operating the fluid device through a variable IGV control method when it is difficult to measure the operating frequency depending on the operating environment of the fluid device in an environment where the fluid device operates through the variable IGV control method, or when it is impossible to measure the operating frequency due to damage to a frequency measurement sensor.

According to an embodiment of the disclosure to achieve the above-described object, there is provided a virtual sensing method for sensing a variable IGV control fluid device operating frequency based on a metamodel, the virtual sensing method including: collecting, by a communication unit, input characteristic data from a fluid device system; and predicting, by a processor, output characteristic data by applying the input characteristic data to a metamodel which is a machine learning model, wherein the input characteristic data is two or more of a fluid pressure (P), a fluid flow rate (Q), and an IGV angle (β), wherein the output characteristic data is an operating frequency (N) of the fluid device.

Prior to predicting the output characteristic data, the metamodel may be configured by using characteristic data (input characteristic data and output characteristic data) which is collected during a shop test finally performed before the metamodel is released and during a test operation performed before or after the metamodel is released.

In addition, a basic model of the metamodel may use a numerical model capable of performing nonlinear regression.

In addition, the metamodel may be configured by a P-Q-N prediction model which uses the fluid pressure (P), the fluid flow rate (Q), and the operating frequency (N) of the fluid device as characteristic data, and a P-Q-β prediction model which uses the fluid pressure (P), the fluid flow rate (Q), and the IGV angle (β) as characteristic data.

In addition, the P-Q-N prediction model and the P-Q-β prediction model may be generated by training a basic model in a supervised learning method.

The P-Q-N prediction model may predict the operating frequency (N) by using information on the fluid pressure (P) and the fluid flow rate (Q), and the P-Q-β prediction model may predict the IGV angle (β) by using information on the fluid pressure (P) and the fluid flow rate (Q).

Predicting may include, when all the fluid pressure (P), the fluid flow rate (Q), and the IGV angle (β) are collected, but any one of the collected fluid pressure (P), fluid flow rate (Q), and IGV angle (β) exceeds a threshold value which is set for each characteristic data, excluding the characteristic data exceeding the threshold value and applying two other characteristic data to the metamodel.

Predicting may include: when all the fluid pressure (P), the fluid flow rate (Q), and the IGV angle (β) are collected, but the collected fluid pressure (P) or fluid flow rate (Q) exceeds a threshold value set for each characteristic data, excluding the fluid pressure (P) or fluid flow rate (Q) that exceeds the threshold value; predicting the fluid pressure (P) or the fluid flow rate (Q) that is excluded through the P-Q-β prediction model; and predicting the operating frequency (N) by applying the fluid pressure (P) or fluid flow rate (Q) that is predicted through the P-Q-β prediction model, and the collected fluid flow rate (Q) or fluid pressure (P) to the P-Q-N prediction model.

Predicting may include: when all the fluid pressure (P), the fluid flow rate (Q), and the IGV angle (β) are collected, but the collected IGV angle (β) exceeds a set threshold value, excluding the collected IGV angle (β); and predicting the operating frequency (N) by applying the fluid pressure (P) and the fluid flow rate (Q) to the P-Q-N prediction model.

According to another embodiment of the disclosure, there is provided a virtual sensing system for sensing a variable IGV control fluid device operating frequency based on a metamodel, the virtual sensing system including: a communication unit configured to collect input characteristic data from a fluid device system; and a processor configured to predict output characteristic data by applying the input characteristic data to a metamodel which is a machine learning model, wherein the input characteristic data is two or more of a fluid pressure (P), a fluid flow rate (Q), and an IGV angle (β), wherein the output characteristic data is an operating frequency (N) of the fluid device.

According to still another embodiment of the disclosure, there is provided a virtual sensing method for sensing a variable IGV control fluid device operating frequency based on a metamodel, the virtual sensing method including: collecting, by a communication unit, input characteristic data from a fluid device system; and predicting, by a processor, output characteristic data by using a metamodel which is used for predicting an operating frequency of a fluid device, wherein the metamodel is configured by a P-Q-N prediction model which uses a fluid pressure (P), a fluid flow rate (Q), and an operating frequency (N) of the fluid device as characteristic data, and a P-Q-β prediction model which uses the fluid pressure (P), the fluid flow rate (Q), and an IGV angle (β) as characteristic data.

According to embodiments of the disclosure as described above, when it is difficult to measure an operating frequency depending on the operating environment of a fluid device in an environment where the fluid device operates through a variable IGV control method, or when it is impossible to measure the operating frequency due to damage to a frequency measurement sensor, a current operating frequency of the fluid device may be predicted by using a metamodel, which is a machine learning model, so that stability in operating the fluid device through the variable IGV control method can be guaranteed.

In addition, since efficiency characteristics of the fluid device changes according to characteristics of the number of rotations of the fluid device, the method and system can contribute to operating frequency feedback control at a planned operating time.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain a configuration of a metamodel-based variable IGV control fluid device operating frequency virtual sensing system according to an embodiment of the disclosure;

FIG. 2 is a view provided to explain a process of configuring a metamodel which is used for predicting a fluid device operating frequency according to an embodiment of the disclosure;

FIG. 3 is a view provided to explain a metamodel-based variable IGV control fluid device operating frequency virtual sensing method according to an embodiment of the disclosure; and

FIG. 4 is a view provided to explain the metamodel-based variable IGV control fluid device operating frequency virtual sensing method in detail according to an embodiment of the disclosure.

### DETAILED DESCRIPTION

Hereinafter, the disclosure will be described in more detail with reference to the accompanying drawings.

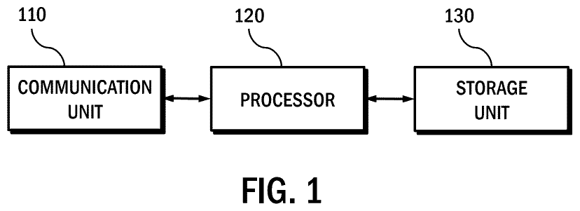

FIG. 1 is a view provided to explain a configuration of a metamodel-based variable IGV control fluid device operating frequency virtual sensing system (hereinafter, referred to as a ‘virtual sensing system’) according to an embodiment of the disclosure.

The virtual sensing system according to an embodiment may predict a current operating frequency of a fluid device by using a metamodel, which is a machine learning model, when it is difficult to measure the operating frequency depending on the operating environment of the fluid device in an environment where the fluid device operates through a variable IGV control method, or when it is impossible to measure the operating frequency due to damage to a frequency measurement sensor.

To achieve this, the virtual sensing system according to an embodiment may include a communication unit 110, a processor 120, and a storage unit 130.

The communication unit 110 is a communication means for connecting to a separate fluid device system through a communication network, and may collect input characteristic data from the fluid device system.

Here, the fluid device system refers to a fluid device system that applies a variable IGV control method, not a typical fluid device system.

The storage unit 130 is a storage medium that stores programs and data necessary for operations of the processor 120.

The processor 130 is provided to process overall operations of the virtual sensing system.

Specifically, the processor 120 may configure (generate) a metamodel by training a basic model of a metamodel in a machine learning method in order to predict an operating frequency of the fluid device, and may predict output characteristic data by applying input characteristic data to the configured metamodel.

Here, the input characteristic data inputted to the metamodel may be two or more data of a fluid pressure (P), a fluid flow rate (Q), and an IGV angle (β), and the output characteristic data outputted as a result of prediction may be an operating frequency of the fluid device.

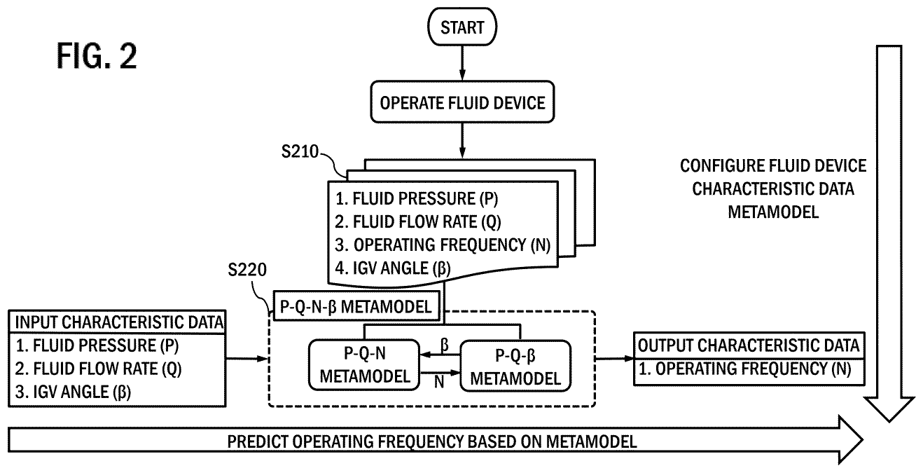

FIG. 2 is a view provided to explain a process of configuring a metamodel which is used for predicting an operating frequency of a fluid device according to an embodiment of the disclosure.

The processor 120 may collect four operating characteristic data (a fluid pressure (P), a fluid flow rate (Q), an IGV angle (β), and an operating frequency (N)) by operating an actual fluid device through the communication unit 110 (S210), and may configure (generate) a metamodel by training a basic model of a metamodel in a machine learning method by using the collected fluid pressure (P), fluid flow rate (Q), IGV angle (β), and operating frequency (N) (S220).

The basic model of the metamodel may use a numerical model capable of performing nonlinear regression, and prior to predicting output characteristic data, the metamodel may be trained by using operating characteristic data (input characteristic data and output characteristic data) which are collected during a shop test which is finally performed before the metamodel is released and during a test operation which is performed before or after the metamodel is released.

Specifically, the metamodel may be configured by a P-Q-N prediction model which uses the fluid pressure (P), the fluid flow rate (Q) and the operating frequency (N) of the fluid device as characteristic data, and a P-Q-β prediction model which uses the fluid pressure (P), the fluid flow rate (Q) and the IGV angle (β) as characteristic data.

The P-Q-N prediction model and the P-Q-β prediction model may be generated by training the basic model in a supervised learning method (individual supervised learning), and the prediction models may predict the operating frequency of the fluid device by interworking with each other, and may also perform mutual prediction between data which has been used for configuring the models.

Specifically, the P-Q-N prediction model may predict the operating frequency (N) by using information on the fluid pressure (P) and the fluid flow rate (Q), and the P-Q-β prediction model may predict the IGV angle (β) by using information on the fluid pressure (P) and the fluid flow rate (Q).

When the P-Q-N prediction model is trained through operating data of a specific fluid device (is used for configuring a model), if the P-Q-N prediction model has information on any one of the fluid pressure (P) and the fluid flow rate (Q) of the corresponding fluid device and information on the operating frequency (N), the P-Q-N prediction model may predict the information (for example, the fluid pressure (P) or the fluid flow rate (Q)) that it does not have.

In addition, when the P-Q-β prediction model is trained through the operating data of the specific fluid device, if the P-Q-β prediction model has information on any one of the fluid pressure (P) and the fluid flow rate (Q) of the corresponding fluid device and information on the IGV angle (β), the P-Q-β prediction model may predict the information (for example, the fluid pressure (P) or the fluid flow rate (Q)) that it does not have.

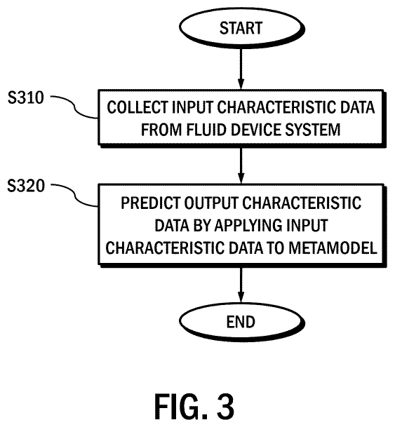

FIG. 3 is a view provided to explain a metamodel-based variable IGV control fluid device operating frequency virtual sensing method according to an embodiment of the disclosure.

The metamodel-based variable IGV control fluid device operating frequency virtual sensing method according to an embodiment may be executed by the virtual sensing system described above with reference to FIGS. 1 to 2.

Referring to FIG. 3, when input characteristic data is collected from the fluid device system through the communication unit 110 (S310), the processor 120 of the virtual sensing system may predict output characteristic data by applying the input characteristic data to the pre-configured metamodel (S320).

That is, when information on two or more of the fluid pressure (P), the fluid flow rate (Q), and the IGV angle (β) is collected, the processor 120 may predict the operating frequency (N) of the fluid device by applying the collected input characteristic data to the P-Q-N prediction model and the P-Q-β prediction model.

Specifically, when information on the fluid pressure (P) and the fluid flow rate (Q) is collected, the processor 120 may predict the operating frequency N of the fluid device by using the P-Q-N prediction model.

When information on any one of the fluid pressure (P) and the fluid flow rate (Q) and information on the IGV angle (β) are collected, the processor 120 may predict information on the fluid pressure (P) or the fluid flow rate (Q) that is not collected (that it does not have) by using the P-Q-β prediction model, and may predict the operating frequency (N) of the fluid device by applying the information on the fluid pressure (P) or the fluid flow rate (Q) that is collected and the information on the fluid pressure (P) or the fluid flow rate (Q) that is predicted to the P-Q-N prediction model.

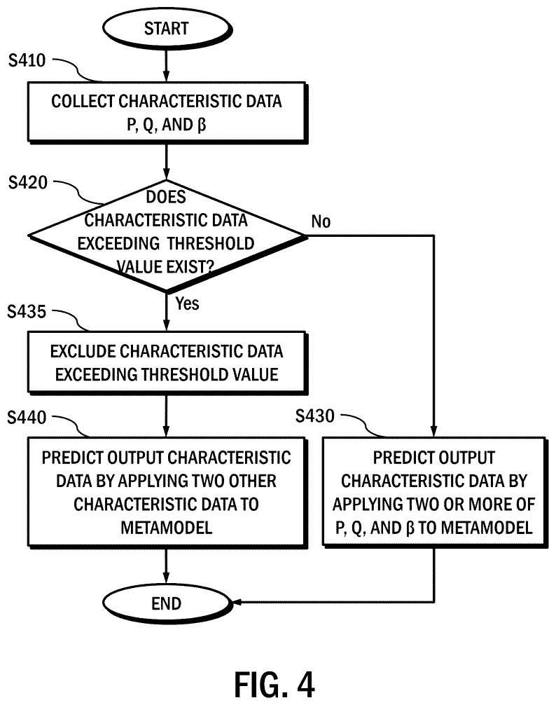

FIG. 4 is a view provided to explain the metamodel-based variable IGV control fluid device operating frequency virtual sensing method in detail according to an embodiment of the disclosure.

Referring to FIG. 4, when all the three types of input characteristic data (the fluid pressure (P), the fluid flow rate (Q) and the IGV angle (β)) are collected from the fluid device system through the communication unit 110 (S410), the processor 120 may determine whether any one of the fluid pressure (P), the fluid flow rate (Q) and the IGV angle (β) exceeds a threshold value which is set for each characteristic data (S420).

In this case, the threshold value may refer to a value that is estimated as being unavailable in operating data of an actual fluid device (due to a breakdown on a sensor of the actual fluid device), and a threshold value (P1) of the fluid pressure (P), a threshold value (Q1) of the fluid flow rate (Q), and a threshold value (β1) of the IGV angle (β) may be individually set according to types of operating characteristic data.

When any one of the fluid pressure (P), the fluid flow rate (Q) and the IGV angle (β) collected does not exceed the threshold value set for each characteristic data (S420—No), the processor 120 may predict the operating frequency (N) of the fluid device by applying two or more of the fluid pressure (P), the fluid flow rate (Q), and the IGV angle (β) to the metamodel (S430).

When any one of the fluid pressure (P), the fluid flow rate (Q) and the IGV angle (β) exceeds the threshold value set for each characteristic data (S420—Yes), the processor 120 may exclude the characteristic data that exceeds the threshold value (S435), and may predict the operating frequency (N) of the fluid device by applying two other characteristic data to the metamodel (S440).

For example, when all the fluid pressure (P), the fluid flow rate (Q) and the IGV angle (β) are collected, but the collected fluid pressure (P) or fluid flow rate (Q) exceeds the threshold value set for each characteristic data, the processor 120 may exclude the fluid pressure (P) or the fluid flow rate (Q) that exceeds the threshold value, and may predict the fluid pressure P or fluid flow rate (Q) that is excluded through the P-Q-β prediction model, and then, may predict the operating frequency (N) by applying the fluid pressure (P) or fluid flow rate (Q) that is predicted (not collected) through the P-Q-β prediction model, and the collected fluid flow rate (Q) or fluid pressure (P) to the P-Q-N prediction model.

In addition, when all the fluid pressure (P), the fluid flow rate (Q) and the IGV angle (β) are collected, but the collected IGV angle (β) exceeds the set threshold value, the processor 120 may exclude the collected IGV angle (β) and may predict the operating frequency (N) by applying the fluid pressure (P) and the fluid flow rate (Q) to the P-Q-N prediction model.

Meanwhile, the processor 120 may configure a plurality of P-Q-N prediction models in the metamodel, and may select a P-Q-N prediction model that has the best accuracy performance (prediction accuracy of the operating frequency (N)) and may use the selected P-Q-N prediction model in predicting the operating frequency (N).

Specifically, the processor 120 may train a first P-Q-N prediction model which, when all of the fluid pressure (P), the fluid flow rate (Q), and the IGV angle (β) are collected, predicts the operating frequency (N) by using information on the fluid pressure (P) and the fluid flow rate (Q), a second P-Q-N prediction model which does not use the collected fluid pressure (P) and predicts the operating frequency (N) by using a fluid pressure (P) that is predicted by applying information on the fluid flow rate (Q) and the IGV angle (β) collected to the P-Q-β prediction model, and information on the collected fluid flow rate (Q), and a third P-Q-N prediction model which does not use the collected fluid flow rate (Q) and predicts the operating frequency (N) by using a fluid flow rate (Q) that is predicted by applying information on the fluid pressure (P) and the IGV angle (β) collected to the P-Q-β prediction model, and information on the collected fluid pressure (P), and then, may select a P-Q-N prediction model that has the best prediction accuracy of the operating frequency N for the operating data of the specific fluid device and may use the selected P-Q-N prediction model in predicting the operating frequency N.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A virtual sensing method for sensing a variable IGV control fluid device operating frequency based on a metamodel, the virtual sensing method comprising:
collecting, by a communication unit, input characteristic data from a fluid device system; and
predicting, by a processor, output characteristic data by applying the input characteristic data to a metamodel which is a machine learning model,
wherein the input characteristic data is two or more of a fluid pressure (P), a fluid flow rate (Q), and an IGV angle (β),
wherein the output characteristic data is an operating frequency (N) of the fluid device.

2. The virtual sensing method of claim 1, wherein, prior to predicting the output characteristic data, the metamodel is configured by using characteristic data (input characteristic data and output characteristic data) which is collected during a shop test finally performed before the metamodel is released and during a test operation performed before or after the metamodel is released.

3. The virtual sensing method of claim 2, wherein a basic model of the metamodel uses a numerical model capable of performing nonlinear regression.

4. The virtual sensing method of claim 1, wherein the metamodel is configured by a P-Q-N prediction model which uses the fluid pressure (P), the fluid flow rate (Q), and the operating frequency (N) of the fluid device as characteristic data, and a P-Q-β prediction model which uses the fluid pressure (P), the fluid flow rate (Q), and the IGV angle (β) as characteristic data.

5. The virtual sensing method of claim 4, wherein the P-Q-N prediction model and the P-Q-β prediction model are generated by training a basic model in a supervised learning method.

6. The virtual sensing method of claim 4, wherein the P-Q-N prediction model is configured to predict the operating frequency (N) by using information on the fluid pressure (P) and the fluid flow rate (Q), and
wherein the P-Q-β prediction model is configured to predict the IGV angle (β) by using information on the fluid pressure (P) and the fluid flow rate (Q).

7. The virtual sensing method of claim 6, wherein predicting comprises, when all the fluid pressure (P), the fluid flow rate (Q), and the IGV angle (β) are collected, but any one of the collected fluid pressure (P), fluid flow rate (Q), and IGV angle (β) exceeds a threshold value which is set for each characteristic data, excluding the characteristic data exceeding the threshold value and applying two other characteristic data to the metamodel.

8. The virtual sensing method of claim 7, wherein predicting comprises:
when all the fluid pressure (P), the fluid flow rate (Q), and the IGV angle (β) are collected, but the collected fluid pressure (P) or fluid flow rate (Q) exceeds a threshold value set for each characteristic data, excluding the fluid pressure (P) or fluid flow rate (Q) that exceeds the threshold value;
predicting the fluid pressure (P) or the fluid flow rate (Q) that is excluded through the P-Q-β prediction model; and
predicting the operating frequency (N) by applying the fluid pressure (P) or fluid flow rate (Q) that is predicted through the P-Q-β prediction model, and the collected fluid flow rate (Q) or fluid pressure (P) to the P-Q-N prediction model.

9. The virtual sensing method of claim 7, wherein predicting comprises:
when all the fluid pressure (P), the fluid flow rate (Q), and the IGV angle (β) are collected, but the collected IGV angle (β) exceeds a set threshold value, excluding the collected IGV angle (β); and
predicting the operating frequency (N) by applying the fluid pressure (P) and the fluid flow rate (Q) to the P-Q-N prediction model.

10. A virtual sensing system for sensing a variable IGV control fluid device operating frequency based on a metamodel, the virtual sensing system comprising:
a communication unit configured to collect input characteristic data from a fluid device system; and
a processor configured to predict output characteristic data by applying the input characteristic data to a metamodel which is a machine learning model,
wherein the input characteristic data is two or more of a fluid pressure (P), a fluid flow rate (Q), and an IGV angle (β),
wherein the output characteristic data is an operating frequency (N) of the fluid device.

11. A virtual sensing method for sensing a variable IGV control fluid device operating frequency based on a metamodel, the virtual sensing method comprising:
collecting, by a communication unit, input characteristic data from a fluid device system; and
predicting, by a processor, output characteristic data by using a metamodel which is used for predicting an operating frequency of a fluid device,
wherein the metamodel is configured by a P-Q-N prediction model which uses a fluid pressure (P), a fluid flow rate (Q), and an operating frequency (N) of the fluid device as characteristic data, and a P-Q-β prediction model which uses the fluid pressure (P), the fluid flow rate (Q), and an IGV angle (β) as characteristic data.
